(19) United States
(12) Patent Application Publication
(10) Pub. No.: US 2015/0324857 A1
(43) Pub. Date: Nov. 12, 2015

(54) CROSS-PLATFORM ADVERTISING SYSTEMS AND METHODS

(71) Applicant: TapFwd, Inc., San Francisco, CA (US)

(72) Inventors: Edward Siegel, San Francisco, CA (US); Alexander Wasserman, San Francisco, CA (US)

(21) Appl. No.: 14/685,543

(22) Filed: Apr. 13, 2015

Related U.S. Application Data
(60) Provisional application No. 61/979,828, filed on Apr. 15, 2014.

(51) Int. Cl. G06Q 30/02

(52) U.S. Cl. CPC G06Q 30/0267; G06Q 30/0269

(57) ABSTRACT

The present disclosure provides a method for aggregating user data from multiple data sources for use in mobile targeted advertising, comprising receiving a first data set and a second data set. The first data set comprises a mobile device identifier that uniquely identifies a mobile electronic device of a user and a first non-mobile identifier. The second data set includes the first non-mobile identifier and a second non-mobile identifier. Next, the first data set is compared to the second data set to identify the first non-mobile identifier as a match between the first data set and the second data set. The mobile device identifier is then associated with the second non-mobile identifier to generate a profile of the user that is stored in computer memory in a manner that is indicative of an association between the mobile device identifier and the second non-mobile identifier.

### CROSS-REFERENCE

This application claims priority to U.S. Provisional Patent Application No. 61/979,828, filed Apr. 15, 2014, which is entirely incorporated herein by reference.

### BACKGROUND

Mobile devices have been traditionally isolated from the offline and desktop advertisement markets, due at least in part to the difficulty of connecting the unique user identifiers used within the offline and desktop advertisement markets to a mobile device of a user. Moreover, user browsing information is typically lost between mobile browsing sessions on the same device, unless the user is explicitly logged in through a user-entered, unique identifier, such as an electronic mail address (email address). These problems may arise due to the lack of hypertext transfer protocol (HTTP) third party cookie support on mobile devices.

Many have attempted to resolve this issue. For example, mobile applications identify unique devices through a unique advertisement identifier, but are only capable of targeting advertisements to the user based on information collected within the mobile applications. Others, such as cross-device services, have statistically associated HTTP cookies with device identifiers, but since the association is statistically-based and may be an indirect approach for associating a user with a device, these services can have large margins of error.

### SUMMARY

Recognized herein is a need in advertising for a new and useful system and method for associating mobile identifiers with non-mobile identifiers.

The present disclosure provides methods and systems for advertising. Methods and systems provided herein can facilitate the identification of users for targeted advertising.

An aspect of the present disclosure provides a method for aggregating user data from multiple data sources for use in mobile targeted advertising, comprising (a) receiving a first data set that comprises (i) a mobile device identifier that uniquely identifies a mobile electronic device of a user, and (ii) a first non-mobile identifier; (b) receiving a second data set that comprises the first non-mobile identifier and a second non-mobile identifier; (c) using a programmed computer processor to (i) compare the first data set to the second data set and (ii) identify the first non-mobile identifier as a match between the first data set and the second data set; (d) associating the mobile device identifier with the second non-mobile identifier to generate a profile of the user; and (e) storing the user profile having the mobile device identifier and the second non-mobile identifier in computer memory, which user profile is stored in a manner that is indicative of an association between the mobile device identifier and the second non-mobile identifier.

In some embodiments, the user profile further comprises the first non-mobile identifier. In some embodiments, the first data set is received from a first data source and the second data set is received from a second data source that is different than the first data source. In some embodiments, the first data source is the mobile electronic device. In some embodiments, the method further comprises identifying a conflict between the first data set and the second data set, and resolving the conflict prior to generating the user profile. In some embodiments, the method further comprises receiving a third data set that includes the first non-mobile identifier or the second non-mobile identifier, and using the third data set to resolve the conflict. In some embodiments, the method further comprises weighting the first data source and the second data source based on a degree of reliability of each respective data source, and resolving the conflict using the weighting. In some embodiments, the first data set and/or the second data set include raw data that is transformed to yield the first non-mobile identifier and/or the second non-mobile identifier.

In another aspect, the present disclosure provides a computer system for aggregating user data from multiple data sources for use in mobile targeted advertising, comprising a communication interface that is in network communication with a first data source and a second data source; computer memory that stores users profiles associated with mobile electronic devices; and a computer processor coupled to the communication interface and computer memory and programmed to (i) receive a first data set from the first data source, wherein the first data set comprises a mobile device identifier that uniquely identifies a mobile electronic device of a user and a first non-mobile identifier; (ii) receive a second data set from the second data source, wherein the second data set comprises the first non-mobile identifier and a second non-mobile identifier; (iii) compare the first data set to the second data set to identify the first non-mobile identifier as a match between the first data set and the second data set; (iv) associate the mobile device identifier with the second non-mobile identifier to generate a user profile of the user; and (v) store the user profile having the mobile device identifier and the second non-mobile identifier in the computer memory in a manner that is indicative of an association between the mobile device identifier and the second non-mobile identifier.

In some embodiments, wherein the computer processor is programmed to identify a conflict between the first data set and the second data set, and resolve the conflict prior to generating the user profile. In some embodiments, the computer processor is programmed to weight the first data source and the second data source based on a degree of reliability of each respective data source, and resolve the conflict using the weighting.

In another aspect, the present disclosure provides a method for serving targeted advertisement to a mobile electronic device of a user, comprising (a) receiving a mobile device identifier associated with a mobile electronic device of a user over a network, wherein the mobile device identifier uniquely identifies the mobile electronic device of the user; (b) matching the mobile device identifier from the mobile electronic device with a user profile of the user, which user profile includes non-mobile data associated with the mobile device identifier in computer memory; (c) receiving an advertisement request over a network, which advertisement request includes a target profile provided by an advertiser; (d) using a programmed computer processor to compare the target profile to the user profile to determine whether the user profile substantially matches the target profile; and (e) serving the targeted advertisement with for display on the mobile electronic device over the network if the user profile substantially matches the target profile.

In some embodiments, the method further comprises selectively adjusting the target profile based at least in part on a response of the user to the targeted advertisement. In some embodiments, the method further comprises displaying the advertisement on a graphical user interface of the mobile electronic device. In some embodiments, the method further comprises receiving an indication that the advertisement has been viewed by the user on the mobile electronic device. In some embodiments, the method further comprises placing a bid in response to the advertisement request upon determining that the user profile substantially matches the target profile. In some embodiments, the method further comprises serving the advertisement if the bid is determined to be a winning bid. In some embodiments, the non-mobile data is aggregated from raw data from one or more non-mobile data sources, transformed from the raw data to yield the non-mobile data, and stored in the computer memory in a manner that is indicative of an association between the non-mobile data and the mobile device identifier. In some embodiments, the method further comprises, in (d), raising the user profile to a level of abstraction of the target profile, and comparing the target profile to the user profile at the level of abstraction. In some embodiments, the method further comprises analyzing the user profile to determine another target profile as a derivative of the target profile, and presenting the another target profile to the advertiser for use in an advertisement campaign.

In another aspect, the present disclosure provides a non-transitory computer-readable medium comprising machine executable code that, upon execution by one or more computer processors, implements any of the methods above or elsewhere herein.

In another aspect, the present disclosure provides one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates a workflow for providing an advertisement to a mobile device of a user;

FIG. 2 schematically illustrates a workflow for associating a mobile device identifier of an electronic device of the user with identifying information of the user;

FIG. 3 is an example of data that may be compiled from various data sources;

FIG. 4 is a schematic representation of associating non-mobile user data with mobile user data.

FIG. 5 is a schematic representation of targeted advertising.

FIG. 6 is another example of associating non-mobile user data with mobile user data.

FIG. 7 is an example of associating non-mobile user data with mobile user data.

FIG. 8 is a schematic representation of weighting data source vectors and eliminating vector conflicts within the set of data records associated with a user.

FIG. 9 is an example of an advertisement request selection interface.

FIG. 10 is an example of an advertisement campaign control interface.

FIG. 11 is an example of tracked campaign data display.

FIG. 12 shows a computer system that is programmed or otherwise configured to implement systems and methods of the present disclosure.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The terms “mobile identifier” and “mobile device identifier,” as used herein, generally refer to identifying information of a mobile (or portable) electronic device. A mobile identifier can uniquely identify the mobile electronic device. A mobile identifier by itself may not be unique, but in association with other factors, such as timestamp or location (e.g., geographic location or zip code) of a user, may be unique. For example, a mobile identifier can uniquely identify a mobile electronic device from other mobile electronic devices. Examples of mobile identifiers are a unique device identifier (UDID) and advertising identifiers, such as identifier for advertisers (IDFA) or Android identifier (AAID). Other examples of mobile identifiers include device fingerprints that can include identifying information of a mobile device (e.g., installed software (apps), settings, and/or clock drift). Such mobile identifiers can be stored locally on mobile electronic devices, in some cases stored in encrypted form. A mobile identifier may not include any identifying information of a user of the mobile electronic device. As such, a mobile identifier can anonymously and uniquely identify a mobile electronic device.

A mobile identifier can be a string of characters or combinations of strings. For example, a mobile identifier is a string of characters, such as letters and numbers. A mobile identifier can be of various lengths, such as at least about 5, 6, 7, 8, 9, 10, 15, 20, 25, 30, 31, 32, 33, 34, 35, 36, 37, 38, 39, or 40 characters in length. In an example, a mobile identifier is a unique string of characters (e.g., 65DED63A-088C-448D-B0E8-16761544698D, 634d21c7-1246-4fd7-9a8f-2331a4aa93f7, or 354387060054700). In another example, a mobile identifier includes two or more strings of characters that may not be individually unique, but the combination of the two or more strings of characters yields a unique combination.

The term “non-mobile” data, as used herein, generally refers to data of or related to a user that is not a mobile identifier. Examples of non-mobile data include a user's name, physical address, electronic mail (email) address, postal (or zip) code, work interests, education interests, social interests, work history, education history, credit card number, or social security number. Non-mobile data can include strings of characters, such as strings of letters or numbers.

The term “non-mobile” identifier, as used herein, general refers to information that identifies a user, which can be generated from non-mobile data.

The term “conversion,” as used herein, generally refers to an instance in which an advertisement that has been presented to a user is accessed by the user. Such access may be a user clicking on the advertisement, visiting an advertiser associated with the advertiser, or purchasing an item from the advertiser. For example, if a user is presented with 10 advertisements and views 5 of the advertisements, the conversion rate is 50% based on the number of instances in which the user accesses the advertisement, as may be determined by a click, mouse-over, finger-over, viewing time, sharing or other access of the advertisement by the user.

### Methods for Identifying Users of Mobile Devices

The present disclosure provides systems and methods for associating a mobile device of a user with identifying information of the user, such as non-mobile information about the user. Such non-mobile information can include non-mobile data. This can enable the user to be readily identified using a mobile identifier (e.g., unique identifier) of the mobile electronic device of the user, in some cases without any other identifying information of the user from the mobile electronic device of the user. The mobile identifier can be used to identify non-mobile descriptive information about a user (e.g., demographics, interests, or purchase behavior).

Such approach can advantageously enable identifying information of the user to be identified through the unique identifier, which can permit, for example, advertising material to be more accurately directed to the user, in some cases permitting the placement of a bid to provide advertising content to a user that is determined to be likely (e.g., greater than 50% more likely to convert as compared to not using this approach) to view given advertising content. This can aid in increasing and in some cases maximizing capture of advertising content.

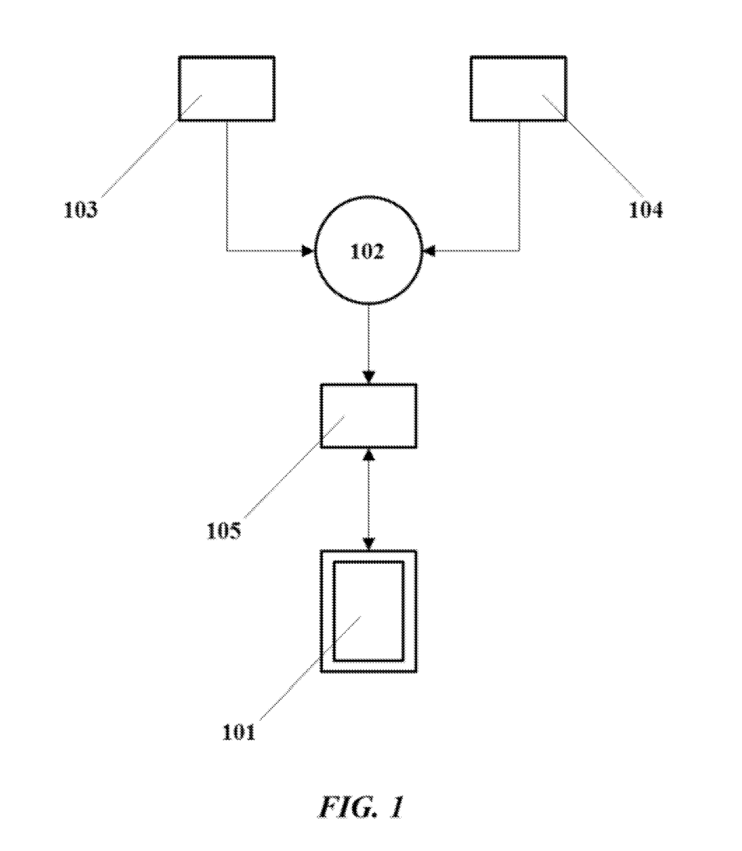

FIG. 1 schematically illustrates a workflow for providing an advertisement to a mobile device 101 of a user. The computer system 102 collects data from multiple data sources 103 and 104, which can include mobile devices and non-mobile devices (e.g., third party sources). The data collected by the computer system 102 can then be used to associate the user with a mobile device identifier of the mobile device 101. In some cases, this includes associating the mobile device identifier with a user profile of the user on the computer system 102. The mobile device identifier may be a UDID and may not include any identifying information of the user. Next, upon receiving an advertisement request from an advertisement network 105, the computer system 102 places a bid for the advertisement request. The bid may be a function of a level of confidence that the UDID matches the user profile (i.e., that the UDID is associated with the user)—for example, a higher bid may be placed if the user (or mobile device) profile is greater than 50% likely to match a given UDID as opposed to the UDID being 50% or less likely to match the UDID. For example, a higher bid can be placed if (i) the UDID is determined to match a user based on deterministic matching as opposed to probabilistic matching, (ii) the data in the profile is more accurate than a threshold, such as the user being a male with 70% confidence (higher bid) as opposed to 50% confidence (normal bid), or (iii) the data in the profile indicates a higher value user (e.g., the profile says this person is interested in sports, and individuals that are interested in sports are 20% more likely to convert, in which case a 20% increase in a bid may be made). Upon winning the bid, the computer system 102 can provide an advertisement that is selected for the user to the mobile device 101. This enables the computer system 102 to identify advertising content that is determined to be of interest to the user, which in turn can enable improved conversion of the advertisement.

As an alternative, the computer system 102 can have a direct relationship with a publisher (e.g., application publisher) and can decide directly what ads to place, in some cases with no ad network intermediary. In such a case, the workflow of FIG. 1 can be used to (a) decide which advertisement to show the user and (b) depending on the relationship with the publisher, decide on how much to pay to place the advertisement.

In some cases, data for associating the user with a mobile device identifier of the mobile device 101 can be provided by one or more third parties. An advertiser can provide a list of non-mobile identifiers of users (e.g., email addresses), which can then be provided to such one or more third parties. Such one or more third parties can each include a database having non-mobile identifiers coupled to mobile device identifiers. The database can be used to translate the list from the non-mobile identifiers to mobile device identifiers. The mobile device identifiers can be included in a list (e.g., list of non-mobile identifiers coupled to mobile device identifiers). The list can be used by the computer system 102 to provide advertisements to various mobile device identifiers.

In an example, a client (e.g., advertiser) provides the computer system 102 a list of email addresses. Next, a list of mobile identifiers is generated using the database of the one or more third parties. The list of mobile identifiers associates the email addresses with mobile identifiers. Next, the computer system 102 uses the mobile identifiers to provide advertisements. This permits the computer system 102 to provide advertisement that is targeted to users of the email addresses.

In some examples, mobile identifiers and non-mobile identifiers can be anonymized, which can help provide user privacy. This can be performed using a hash function, such as, for example, MD5 or SHA-1.

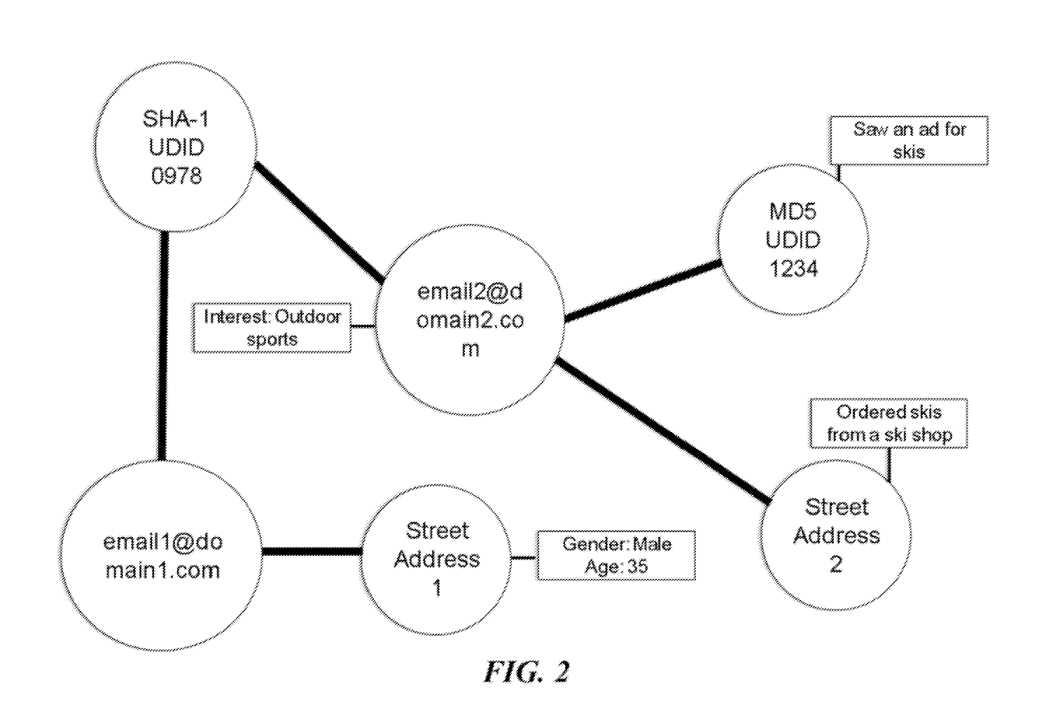

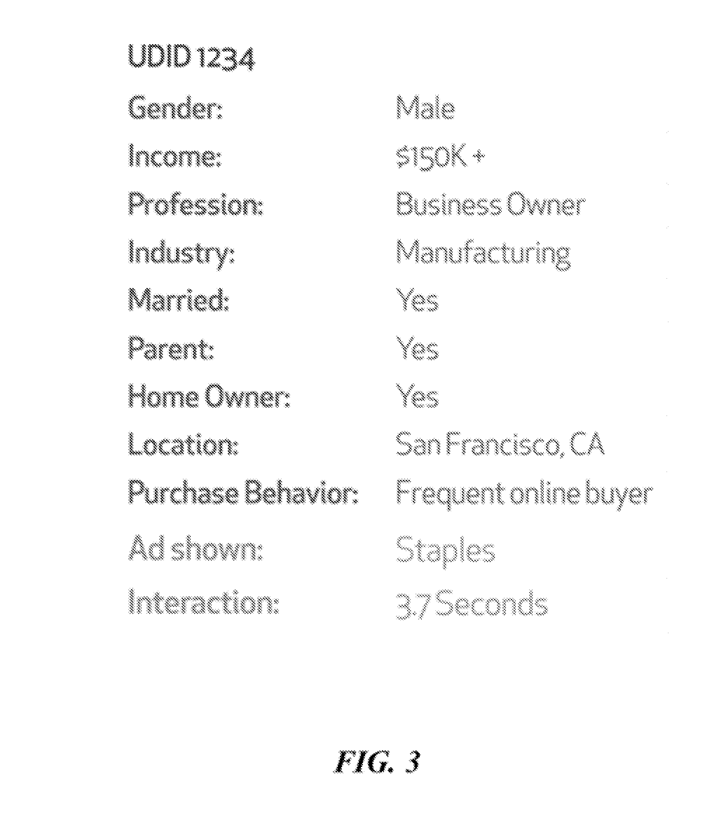

The present disclosure also provides methods for associating a mobile device identifier with a user. In an example, FIG. 2 schematically illustrates a workflow for associating a mobile device identifier of an electronic device of the user with identifying information of the user. The workflow can be facilitated by a computer system that is programmed to associate the mobile identifier with the identifying information of the user. The computer system can aggregate the identifying information from various sources, such as network sources (e.g., email) and third party sources (e.g., merchant information). Such association can be made based on the overlap between data from individual data sources. For example, a first data source includes a UDID of the mobile device and an email address, and a second data source includes the email address, postal code and name of the user. The computer system draws an association between the UDID and the email address, postal code and the name of the user. This permits the computer system to identify the user using solely the UDID of the mobile device of the user. Other information (e.g., gender, marital status, industry, income, location, etc.) of the user may be aggregated and associated with the UDID using other data sources. An example of data that may be compiled using such approach is shown in FIG. 3.

The mobile identifier can be associated with identifying information of a user at a confidence score. Such confidence score can be a function of the number of data sources that have been used by the computer system to verify the association. For example, two data sources are used to associate a UDID with an email address and name of a user. A third data source is then used to verify that the UDID is associated with other identifying information of the user, including the name of the user. The third data source can permit an association between the UDID and the email address and name of the user at an increase confidence score. The confidence score can be increased by eliminating vector conflicts, which can include weighting or prioritizing data sources, as described elsewhere herein.

In some cases, data sources that enable information to be matched (e.g., UDID with non-mobile data) in a deterministic manner can be trusted over data sources that enable information to be matched in a probabilistic manner. For example, a trusted data source can permit a UDID to be matched with non-mobile data deterministically, whereas a less trusted data source can permit the UDID to be matched with non-mobile data probabilistically.

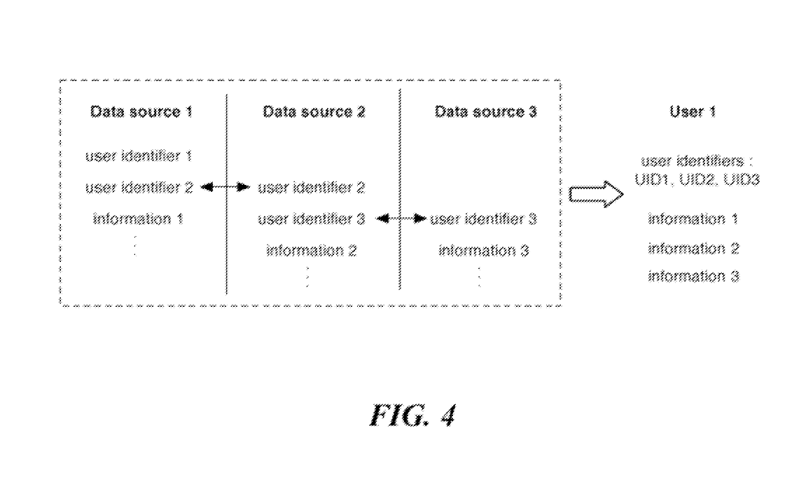

FIG. 4 schematically illustrates matching user data, such as non-mobile data, from various data sources (Data source 1, Data source 2 and Data source 3). This can be used to associated such user data with a mobile identifier, which can enable the mobile identifier to be associated with a non-mobile identifier of the user.

Methods of the present disclosure enable targeted advertising by matching a mobile device identifier with a user profile using data from a set of data sources, determining whether the user profile is a fit with an advertisement request, serving an advertisement associated with the advertisement request to the mobile device associated with the mobile device identifier, and selectively adjusting the targeted audience profile based on a response received from the mobile device. This can be used for targeting advertisements to mobile device users based on data (e.g., advertisement profiles) from secondary sources. The secondary sources can include desktop cookies, postal advertising sources, purchase history sources, retail advertising sources, or any other suitable advertisement profile source.

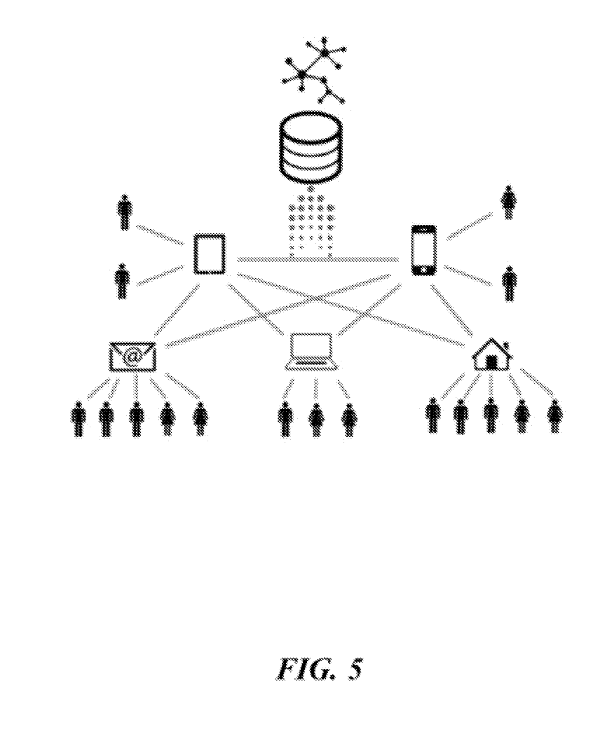

Non-mobile data can be associated with mobile user data. The mobile user data can include the mobile device identifier, as well as identifying information of the user. Mobile user data can be compared across various mobile devices. This is schematically illustrated in FIG. 5. Data from various sources (in some cases disparate sources) can be collected and stored in a unified way.

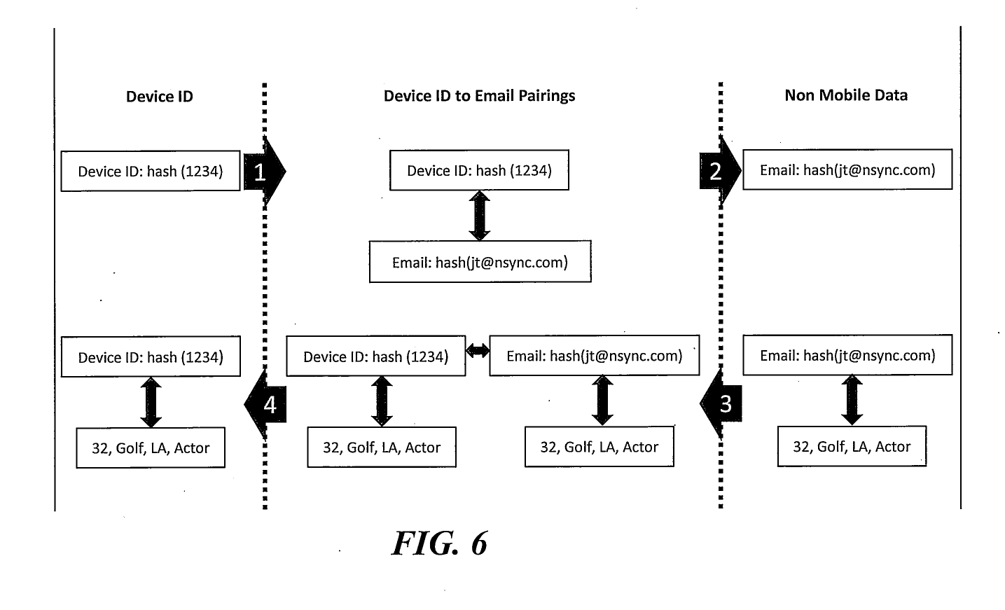

FIG. 6 shows another example of associating non-mobile user data with mobile user data. The association can be implemented by a computer system that is programmed or otherwise configured to collect user data and determine an association between non-mobile user data and mobile user data. First, the computer system collects a device identifier (Device ID). The Device ID can be collected from the mobile device or another computer system. Next, the computer system performs a Device ID to email pairing to provide an association between the Device ID and the email. The pairing can be performed using a lookup table, for example. The lookup table can provide an association between the Device ID and the email. Next email is used to draw one or more associations to non-mobile data, such as the age of the user, sports interests of the user (e.g., golf), a location of the user (e.g., Los Angeles) and a profession of the user (e.g., actor). Next, the non-mobile data is associated with the Device ID. This can then be used to determine whether an advertisement associated with an advertisement request is to be served to the mobile device associated with the Device ID.

By using previously unused data sources to link the advertisement profiles sources to the mobile device identifier, methods of the present disclosure can confer several non-limiting benefits. First, wasted impressions to the user can be reduced. For example, this method can enable frequency caps on impressions to the user (e.g., instead of applying to the frequency cap to the device), which can result in a more efficient use of the advertising budget (e.g., less money wasted on repeating an advertisement to the same user), increase the reach of the advertisement, and in some cases result in a higher conversion rate. Second, the large amount of information from the disparate data sources can generate a better profile for the user, which can result in better advertisement targeting. This can enable advertisers to more accurately direct advertising content to users of mobile electronic devices, which would ordinarily be difficult given that identifying information of such users is typically not available.

Matching a mobile device identifier with a user profile using data from a set of data sources can link the mobile device identifier to other data about a given user, such as pre-existing data. In some cases, data from the set of data sources is raw data that is collected and subsequently transformed (e.g., formatted to permit comparison) to yield data that is usable to permit the matching. Such data can then be stored in computer memory in a manner that is indicative of an association between the data and the mobile device identifier.

Matching a mobile device identifier with a user profile can include identifying a common parameter for a user across a first and second data source, aggregating records having the common user parameter, and associating a user profile with the common parameter. Such user profile with the association to the mobile device identifier can be stored in computer memory, such as in a data file. This can enable subsequent identification of the user profile from the mobile device identifier. For example, if the mobile device identifier is all of the information that is available, the association between the mobile device identifier and the user profile can enable the user and other information about the user to be readily identified.

The data sources used to match the mobile device identifier with the user profile can include data having a first and a second parameter. The first and second parameters can be unique, such that each can be subsequently used to link a second piece of data to the first piece of data. However, the data can alternatively have a single unique parameter, or any other suitable number of parameters. The data can additionally include a user profile. Examples of unique parameters include an identifier for a specific device (e.g., mobile device identifier), such as a unique device identifier (UDID), identifier for advertisers (IDFA), Android™ ID, an encoded device identifier, an IP address, an advertisement identifier (e.g., specific to an application but that consistently identifies a mobile device), an email address (e.g., encoded or unencoded), a postal code, a name, a location, a pattern of traversed locations, a credit card number, a social security number, or any other suitable parameter that can uniquely identify a user. A unique parameter can be a combination of non-unique parameters. In some examples, parameters A and B are individually not unique, but the combination of A and B is unique. For example, a last name and city individually may not be unique, but the combination of a last name and a city may provide a unique combination in the city and in some cases beyond. The data sources can include cellular location data (e.g., including a location, a timestamp, and a device identifier), cross-device data (e.g., data that statistically links a mobile device identifier with a cookie uniquely associated with a user or secondary device), mobile applications (e.g., Pandora, including an advertisement identifier and an email address), multiscreen services (e.g., Netflix), mailing data (e.g., including a name and a postal address), or any other suitable data source. The data can be purchased from the data sources, such as third parties, but the data can alternatively be otherwise collected. The data sources can be remote with respect to the computer system that draws an association between the mobile device identifier and the user profile. Such data sources can be access by the computer system over a network.

A unique parameter can be a combination of 2 or more non-unique parameters. The number of non-unique parameters that define a unique parameter can be selected to optimize or maximize the chances that the unique parameter is unique. For example, if a last name and city combination may not yield a unique combination, an additional parameter (e.g., profession or birth year) may be added to yield a unique parameter.

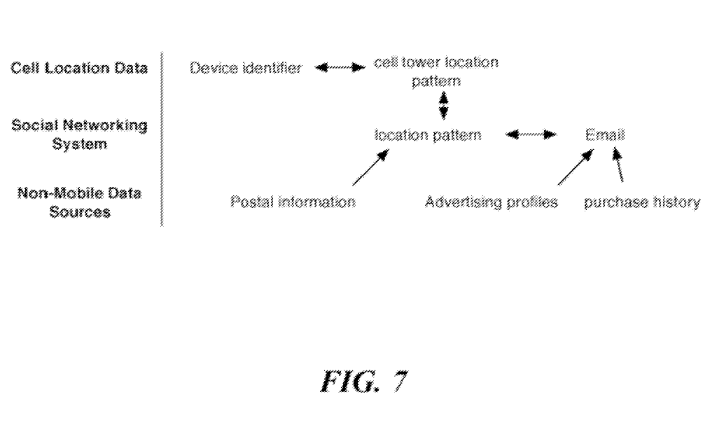

The data from the data sources can be cross-indexed. In such a case, records with matching identifiers can be identified and aggregated into a set of data records associated with the user. For example, a first unique parameter and a second unique parameter can be identified in a first piece of data, the first unique parameter can be identified in a second piece of data, and the second unique parameter can be identified in a third piece of data. The first, second, and third pieces of data can be aggregated into the user set of data records. In an example, as shown in FIG. 7, a device identifier and a pattern of location over time can be extracted from cellular location data or other geographic location (geolocation) data, and the pattern of locations over time can be identified (e.g., approximated or matched within a margin of error) in a social networking service (e.g., through geotagged Facebook or Twitter posts). The geolocation data can be obtained from a mobile electronic device of a user. An email address associated with the pattern of locations over time can be extracted in the social networking service (e.g., Facebook and/or Twitter) and stored in computer memory, and the email address associated with the device identifier can be determined from the cellular location data. The user profile associated with the email address by a cross-device system can additionally be associated with the device identifier through the email address. In another example, the device identifier is matched to an email address or other unique, cross-device user identifier using a first data source, the user identifier is associated with a user profile using a second data source, and the user profile is linked to the device identifier through the unique user identifier.

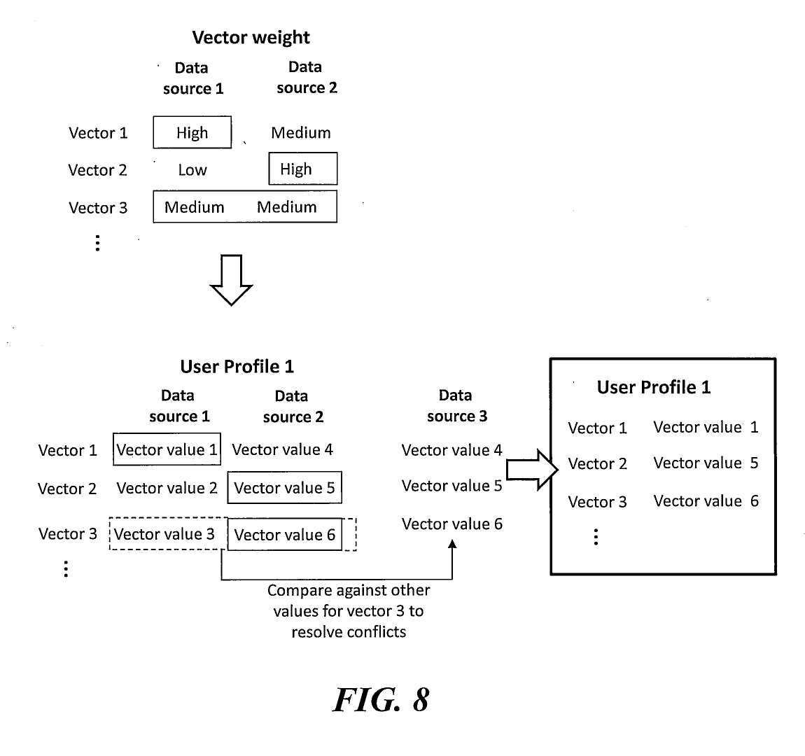

Matching the device identifier with a user profile can additionally include eliminating vector conflicts within the user set of data records, as shown in FIG. 8. A vector can be a measurable or quantifiable aspect of a user. Examples of vectors can include user name, age, purchase history, preferences (e.g., food, retail, etc.), location at a given point in time, or any other suitable user aspect that can be tracked, quantified and/or measured. Vector value discrepancies can arise within the multiple disparate data sources, either due to tracking or measurement errors, or because the user entered the conflicting information. Eliminating vector conflicts within the user set of data records can also provide for the generation of a more accurate advertising profile for the user. Eliminating vector conflicts within the user set can better link user information with unique user identifiers by removing or reducing the influence of conflicting signals, such as signals stemming from multi-user devices.

Eliminating vector conflicts within the user set of data records can include weighting or prioritizing data sources for each type of vector. Vector value conflicts can be resolved in favor of the data source having the higher weight or priority. For example, a first data source can have a first weight (or score) for a first vector and a second weight (different from the first weight) for a second vector, and a second data source can have a third weight for the first vector (higher than the first weight) and a fourth weight (lower than the second weight) for a third vector.

The vector weights for a data source can be determined based on the reliability and/or accuracy of the data source for the given vector. Higher vector weights can be assigned to more reliable and/or accurate data sources for the given vector.

The vector reliability and/or accuracy of a data source for the given vector can be verified by the data provider or by any other suitable party. For example vector reliability can be proportional to the number of data sources that provide a given vector (e.g., if five data sources say that a given UDID is associated with a male user and one data source says it is associated with a female user, then male is selected). The vector weighting for the respective data source can be based on the relative vector reliability. For example, a first data source can be an IP address provider. The data provided can associate IP addresses with email addresses that were used to register for the IP addresses, and have a first accuracy that is guaranteed by the IP address provider. A second data source can be a third party that statistically associates IP addresses with encoded email addresses, and have a second accuracy, lower than the first accuracy, that is guaranteed by the third party. The IP addresses from the first data source can be given a higher weight or priority than IP addresses from the second data source. In another example, different weights can be assigned to different resolutions of vector categories. In an example, cell tower location data can be very accurate for determining which city a user is located within, and therefore have a high weight or priority for city-level data, but can be inaccurate for determining which block a user is within, and have a low weight or priority for block-level data.

Accuracy information with respect to data sources can be maintained in computer memory and used to assess data collected from the data sources. Such accuracy information can be continuously updated based on data collected from the data sources upon comparison to other data.

The weighting for a data source vector can additionally or alternatively be determined based on the mechanism generating the data of the data source. For example, geolocation data generated by GPS devices can have higher weighting than location data entered by users, which has a higher weighting than location data determined using cell tower triangulation (e.g., as determined from tagged metadata).

The weighting for a data source vector can additionally or alternatively be determined by verifying the accuracy of the vector values of the first data source against the vector values of a second data source. The second data source can have an average or guaranteed accuracy or reliability above a reliability or accuracy threshold (e.g., 50%). The vector weighting for the first data source can be based on the average or median accuracy of the respective vector data. For example, a first data source and second data source can be compared against a third data source. The third data source can have a proven or guaranteed accuracy above a predetermined threshold (e.g., 50%). The average match rate of the first data set vector values can be 50%, while the average match rate of the second data set vector values can be 80%. The second data set can be assigned a higher priority or weighting than the first data set. The threshold can be set by an operator of the computer system used to draw associations between mobile device identifiers and user profiles and can be adjusted based, for example, on conversion rates.

The weighting for a data source vector can additionally or alternatively be determined by verifying the accuracy of the vector values of the first data source against the vector values of multiple data sources. The vector value weighting for the first data source can be increased for each concurring vector value for the unique identifier, such as from a select one of the multiple data sources. The vector value weighting for the first data source can be decreased for each conflicting vector value for the unique identifier if the select one of the multiple data sources is found to be more proven or accurate than the first data source.

The weighting of a data source vector can be determined by verifying the accuracy of the vector value based on responses received from a mobile device of a user that has been targeted for an advertisement. For example, a low conversion rate is indicative of the user profile not matching the mobile device identifier of the user, which in turn indicates that the data sources used to associate the user profile with the mobile device identifier did not provide accurate or reliable data. The weighting of one or more of these data sources can be adjusted.

For example, the values for a given vector (e.g., age) for all data records directly or indirectly associated with the first unique identifier can be extracted. Data sources can be weighted in correlation with the frequency of the respective vector value within the aggregate data set. For example, data sources providing the records having the highest instance of a given vector value can be assigned a high weight (or score) for the vector, while data sources providing the records having the lowest instance of a given vector value are assigned a low weight for the vector.

Alternatively or additionally, the aggregate data set can be iterated through. The vector weight for a given data set can be increased when the vector value of the iterated record meets the vector value for the given data set. Alternatively or additionally, the vector values of a first data source and second source can be compared against a third data source. The vector values of the third data source can be deemed to have a proven or guaranteed accuracy above a predetermined threshold. The average match rate of the first data set vector values can be 50%, while the average match rate of the second data set vector values can be 80%. The second data set can be assigned a higher priority or weighting than the first data set. The vector weight for each data set can be determined from a combination of the above, or determined in any other suitable manner.

The vector weighting can additionally be used to select which data source to purchase vector data from. The selection can be based on the cost of the respective data (from the data source) and the respective vector weighting and/or the respective vector accuracy (e.g., average or median). The selected data source can be the one with the lowest cost of data that has a vector weight or accuracy above a weight or accuracy threshold, respectively, but can alternatively be selected in any other suitable manner. The weight or accuracy threshold can be predetermined, determined based on the advertisement request, or otherwise determined. For example, a first data source can have age data that is 65% accurate on average and has a first price, a second data source can have age data that is 70% accurate on average and has a second price higher than the first price, and a third data source can have age data that is 90% accurate on average and has a third price higher than the second price. The second data source can be selected when the selected accuracy threshold is 69%. Data source selection can be optimized based on cost, accuracy, or any other suitable parameter. The threshold can be set by an operator of the computer system used to draw associations between mobile device identifiers and user profiles and can be adjusted based, for example, on conversion rates.

With reference to FIG. 8, three vectors (Vector 1, Vector 2 and Vector 3) are collected from Data source 1 and Data source 2. The level of accuracy or reliability (“High,” “Medium,” and “Low,” as shown) of the vectors from the data sources is shown in the table (upper left). Next, a user profile (User Profile 1) is generated from the three vectors and stored in computer memory. In resolving the conflict between vector values from the three data sources, the computer system retains a vector value from a data source that has a higher level of accuracy than another data source. For instance, for Vector 1, Vector value 1 from Data source 1 is retained over Vector value 4 from Data source 2 because Vector 1 is found to be more reliable from Data source 1 than Data source 2. This may be the case, for instance, if the type of vector (e.g., postal code) of Vector 1 is more reliable from Data source 1 than Data source 2.

For Vector 3, the computer system can compare the vector values from Data source 1 and Data source 2 to vector values from a third data source, Data source 3, in order to resolve a conflict in which Vector value 3 and Vector value 6 are both from a data source that has a “Medium” level of accuracy. Data source 3 identifies Vector 3 as having Vector value 6, which resolve the conflict. The user profile is then generated having Vector value 1, Vector value 5 and Vector value 6, as shown.

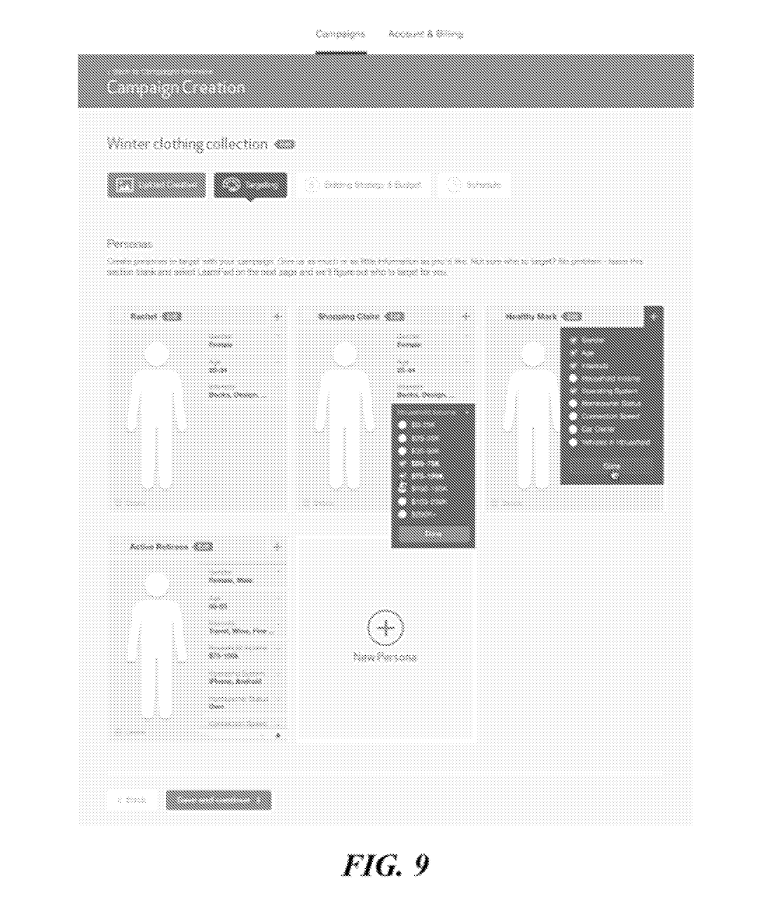

Matching the device identifier with a user profile can additionally include generating the user profile. The user profile can be generated automatically (e.g., by the computer system) or manually (e.g., by a systems administrator). The user profile can be stored in computer memory. The user profile can include a mobile device identifier (e.g., UDID) and identifying information of the user, such as non-mobile information. The user profile can be generated or updated at predetermined frequencies (e.g., on an hourly, daily or weekly basis), but can alternatively be generated or updated in response to receipt of the advertisement request (e.g., as shown in FIG. 9) or in response to the occurrence of any other suitable trigger event, such as based on conversion rate. In some examples, device profiles are recomputed upon retrieving an update from a data source or upon updating an algorithm by which user information is matched (e.g., vector weightings) to generate an association between a user and a mobile identifier. The user profile can be generated based on data from multiple data sources, but can alternatively be extracted from a single data source, or determined in any other suitable manner. The user profile can be determined from a data source that provides a user profile. Alternatively, the user profile can be generated from the highest weighted data (directly or indirectly linked to a unique identifier) that is available for each vector, as determined across all data sets for all data sources.

For example, the user profile for each unique identifier (e.g., in which each user is associated with a single unique identifier) can include age, gender, and a sporting interest. A given unique identifier can have a first and second associated gender, based on a first and second data source. The gender from the data source having the higher vector weight can be selected as the gender for the user profile. The age and sporting interest for the user profile can be selected in a similar manner. Alternatively, for vectors that can include multiple values, such as sporting interest, any value from a data source having a vector weight above a weight threshold can be included in the profile. For example, a first data source having a first sporting interest vector weight can indicate that the user is interested in football, a second data source having a second sporting interest vector weight can indicate that the user is interested in ice skating, and a third data source having a first sporting interest vector weight can indicate that the user is interested in car racing. All three vector values—football, ice skating and car racing—can be included in the user profile if the first, second, and third vector weights are above a weight threshold. The different vector values can be associated with different weights within the user profile. The respective vector value weight can be determined from the vector weight of the data set from which the vector value was extracted, which can be at least partly dependent on the data source from which the data set was obtained. Alternatively or additionally, the respective vector value weight can be determined from the occurrence of the given vector value within records associated with the unique identifier across all data sources (e.g., ice skating can be given a higher weight when more records indicate that the user is interested in ice skating), or be determined in any other suitable manner.

Selecting a mobile device identifier to target in response to receipt of an advertisement request can include selecting a mobile device identifier that substantially matches an advertisement request. The advertisement can be subsequently sent to the mobile device identified by the selected mobile device identifier. The advertisement request can be received from an advertiser, but can be received from an advertisement exchange or any other suitable party. The advertisement request can be received wirelessly or through a wired connection. The advertisement request can include a target profile (e.g., “Climbers 25-35 years in age”). The advertisement request can additionally include an advertising budget, a maximum cost per advertisement unit, such as the cost per thousand impressions (CPM), or any other suitable advertisement parameter. The mobile device identifier can be selected based on the associated user profile. Identifiers with user profiles that substantially match (e.g., within predetermined range or margin of error, such as greater than 50%) the advertisement request can be selected. The user profile of the selected mobile device identifier can satisfy some or all vector values of the advertisement request (e.g., include 27, male, living in California when the advertisement request includes “between 25-30, male, living in California”), but can alternatively have a match percentage with the vector values of the advertisement request above a threshold match percentage (e.g., 50%), satisfy only key vector values (e.g., include an identifier associated with “27, male, living in Nevada” when the advertisement request includes “between 25-30, male, living in California”), or satisfy any other suitable proportion of the advertisement request.

Selecting the mobile device identifier can additionally include abstracting the vector values of the user profile to meet the abstraction level of the advertisement request. For example, if the advertisement request includes “interested in sports,” but a user profile lists “knitting” as an interest, then “knitting” can be abstracted to the same category level as “sports” (e.g., to the “hobbies” category) before it is compared to the advertisement request. In this example, the user profile listing “knitting” may not be match with the advertisement request.

Unique mobile device identifiers (e.g., unique users) can be selected for inclusion in the targeted audience for a given advertisement until the estimated budget is reached. The unique mobile device identifiers can be pre-selected, before an advertisement is served to the set, but can be dynamically selected (e.g., in real time) during the advertisement campaign, or selected at any other suitable frequency (e.g., hourly or daily).

Selecting the mobile device identifiers for inclusion in the targeted audience can additionally include generating a second advertisement (or bid) request. The second advertisement request can have different vector values than the first advertisement request. This can additionally include selecting a subset of mobile device identifiers that satisfy a second advertisement request. This can provide for the identification of new audiences (or users) that were not targeted by the advertisement request.

Generating a second advertisement request can include randomly selecting a set of vector values for any set of vectors, randomly selecting a set of vector values for the set of vectors of the first advertisement request, reversing the vector values for each of the first advertisement request vectors, generating the vector values based on the advertisement (e.g., analyzing the advertisement for themes or keywords and determining a population that is historically receptive to those themes or keywords, such as by using machine learning algorithms), importing vector values based on a second advertisement campaign for a similar product or service, or otherwise generating the second advertisement request. Selecting the subset of device identifiers that satisfy the second advertisement request can include selecting device identifiers associated with user profiles that meet the second advertisement request. Selecting the subset of device identifiers that satisfy the second advertisement request can additionally include selecting a proportion of the advertising budget for use in bidding on the audience of the second advertisement request. The number of device identifiers within the audience can be limited by the advertising budget proportion. The advertising budget proportion can be a percentage of the advertising budget, or a statistically insignificant proportion but can be larger, a predetermined amount, or any other suitable proportion of the advertising budget. A non-conforming identifier population can be selected for advertising campaigns having advertising budgets above a predetermined threshold amount, but can alternatively be selected for any advertising campaign. The advertising budget proportion can be applied to a set of identifiers that satisfies the second advertisement request, but can alternatively be applied to multiple sets of identifiers that each satisfy a different deviant advertisement request.

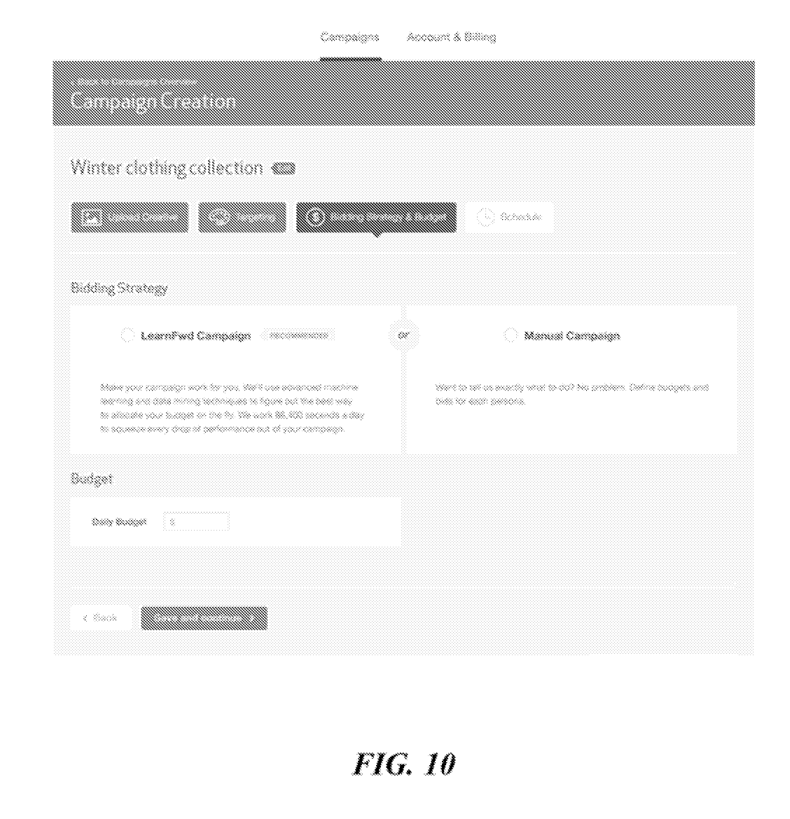

Serving an advertisement associated with the advertisement request to the mobile devices can include sending the advertisement to the mobile devices that are identified by the mobile device identifiers of the advertisement set. Serving the advertisement can include detecting connection of the identified mobile device to the advertising system and serving the advertisement to the mobile device (e.g., sending the advertisement to the mobile device). Serving the advertisement to the mobile device can additionally include tracking the frequency at which the advertisement is sent to a given mobile device. Advertisement serving frequency can be limited to a predetermined or advertiser selected frequency (e.g., once per viewing session, once per identifier, etc.), but can alternatively be unlimited within a given period of time (e.g., weekly, monthly, or year). The advertisements can be automatically sent to the identified audience satisfying the first advertisement request, and can additionally be sent to the audience satisfying the deviant advertisement request (e.g., second advertisement request). Alternatively, the advertisements can be sent to the audience satisfying the deviant advertisement request in response to selection of or a positive response received from a notification sent to the advertiser (e.g., as shown in FIG. 10). The notification can be sent when the advertisement campaign is initiated, after a threshold number of positive responses (e.g., 100 responses) have been received, or in response to the occurrence of any other suitable trigger event. This can advantageously enable the advertiser to identify target audiences that would otherwise not be identified.

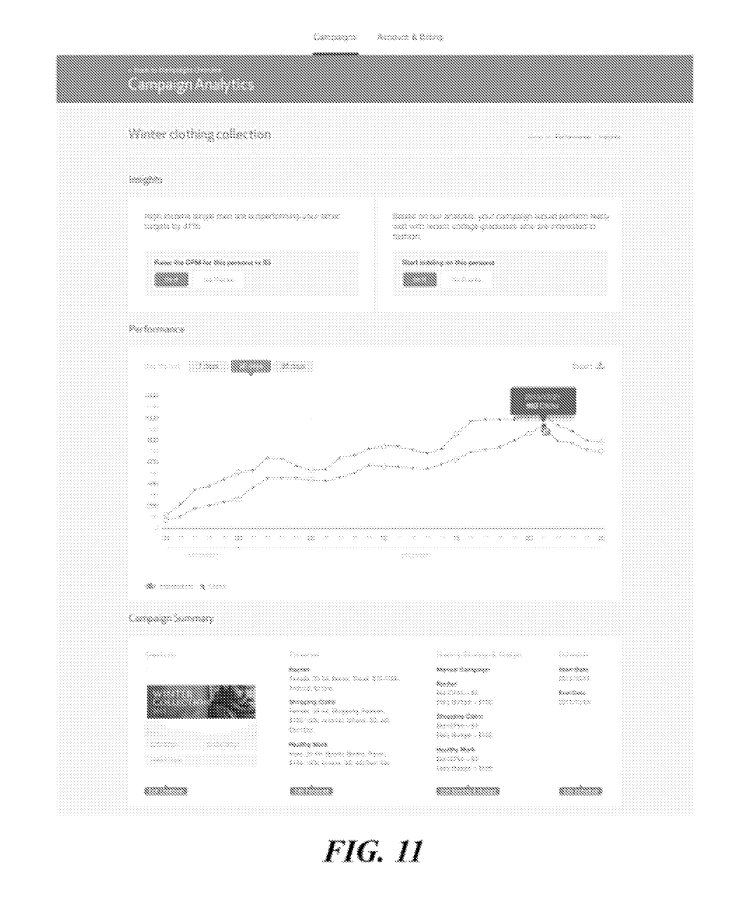

Selectively adjusting the targeted audience profile based on a response received from the mobile device can provide for the use of advertising funds toward users having a higher response rate than the initially targeted audience. Selectively adjusting the targeted advertisement profile based on the responses can include tracking the user responses (e.g., clicks), and enabling the advertiser to adjust the targeted advertisement profile based on the tracked responses (e.g., as shown in FIG. 11). User responses can include positive responses, such as click-throughs, viewing time, sharing (e.g., on social networking systems) or comments, or negative responses, such as electing to skip the advertisement or not purchasing the good or service advertised (e.g., as determined through subsequent payment history associated with the device identifier), but can alternatively include any other suitable user response. The user profiles of the identifiers associated with positive user responses can be analyzed to identify common traits. The common traits can be subsequently used to generate a second advertisement request that targets a subset of the first advertisement request, but may also target other user that may not be included in the first advertisement request. The system can automatically increase the bid amount for mobile device identifiers that meet the second advertisement request. The audience subset can be specifically targeted in response to the number of positive responses from the audience subset surpassing a threshold number (e.g., 100 positive responses), surpassing a threshold percentage (e.g., 50%), or surpassing any other suitable metric.

Alternatively, the audience subset can be gradually targeted. For example, the higher bid rate can be initially bid for every other identifier of the audience subset. The bid frequency can be increased in response to receipt of positive user responses from the audience subset, and decreased in response to receipt of negative user responses from the audience subset. Alternatively, the audience subset can be targeted in response to selection of a notification sent to the advertiser. The notification can be sent in response to the positive responses surpassing a threshold metric, sent in response to a test run targeting the audience subset having a success rate above a predetermined threshold rate, or in response to any other suitable trigger event. However, the tracking information can be otherwise used to dynamically adjust the advertisement campaign.

### Computer Systems

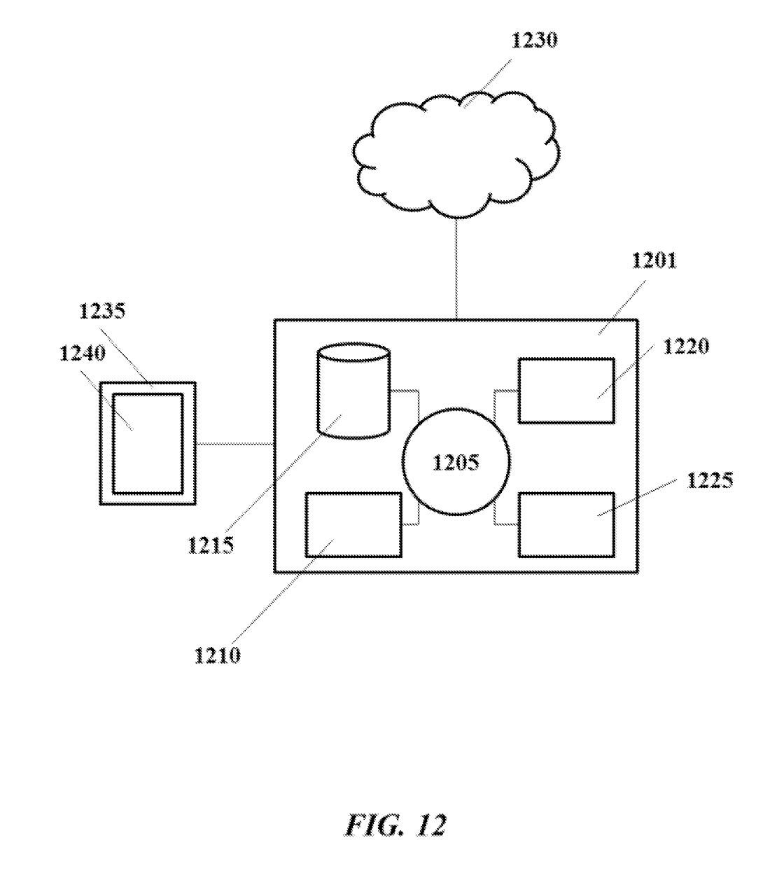

The present disclosure provides computer control systems that are programmed to implement methods of the disclosure. FIG. 12 shows a computer system 1201 that is programmed or otherwise configured to facilitate the selection of advertising content for display to users on mobile electronic devices. The computer system 1201 can regulate various aspects of methods and systems of the present disclosure, such as, for example, generating associations between mobile device identifiers and users, including user profiles, and facilitating the placement of bids in response to advertisement requests. The computer system 1201 can be a computer system that is remotely located with respect to an electronic device of a user. The electronic device can be a mobile electronic device.

The computer system 1201 includes a central processing unit (CPU, also “processor” and “computer processor” herein) 1205, which can be a single core or multi core processor, or a plurality of processors for parallel processing. The computer system 1201 also includes memory or memory location 1210 (e.g., random-access memory, read-only memory, flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an internet and/or extranet, or an intranet and/or extranet that is in communication with the Internet. The network 1230 in some cases is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, and writeback.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and saved programs. The storage unit 1215 can store user data, e.g., user preferences and user programs. The computer system 1201 in some cases can include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user (e.g., user targeted for advertising). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein can be implemented by way of machine (e.g., computer processor) executable code stored on an electronic storage location of the computer system 1201, such as, for example, on the memory 1210 or electronic storage unit 1215. The machine executable or machine readable code can be provided in the form of software. During use, the code can be executed by the processor 1205. In some cases, the code can be retrieved from the storage unit 1215 and stored on the memory 1210 for ready access by the processor 1205. In some situations, the electronic storage unit 1215 can be precluded, and machine-executable instructions are stored on memory 1210.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display 1235 that comprises a user interface (UI) 1240 for providing, for example, advertising content for view by a user. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1205. The algorithm can, for example, generate associations between mobile device identifiers and users, including user profiles, and facilitate the placement of bids in response to advertisement requests.

Methods provided herein can be implemented by way of a computer-readable medium storing computer-readable instructions. The instructions can be executed by computer-executable components integrated with an advertisement system. The advertisement system can include a mobile to non-mobile data source linking system, audience selection system and an audience discovery system. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but the instructions may alternatively or additionally be executed by any suitable dedicated hardware device.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for aggregating user data from multiple data sources for use in mobile targeted advertising, comprising:
(a) receiving a first data set that comprises (i) a mobile device identifier that uniquely identifies a mobile electronic device of a user, and (ii) a first non-mobile identifier;
(b) receiving a second data set that comprises said first non-mobile identifier and a second non-mobile identifier;
(c) using a programmed computer processor to (i) compare said first data set to said second data set and (ii) identify said first non-mobile identifier as a match between said first data set and said second data set;
(d) associating said mobile device identifier with said second non-mobile identifier to generate a profile of said user; and
(e) storing said user profile having said mobile device identifier and said second non-mobile identifier in computer memory, which user profile is stored in a manner that is indicative of an association between said mobile device identifier and said second non-mobile identifier.

2. The method of claim 1, wherein said user profile further comprises said first non-mobile identifier.

3. The method of claim 1, wherein said first data set is received from a first data source and said second data set is received from a second data source that is different than said first data source.

4. The method of claim 1, wherein said first data source is said mobile electronic device.

5. The method of claim 1, further comprising identifying a conflict between said first data set and said second data set, and resolving said conflict prior to generating said user profile.

6. The method of claim 5, further comprising receiving a third data set that includes said first non-mobile identifier or said second non-mobile identifier, and using said third data set to resolve said conflict.

7. The method of claim 5, further comprising weighting said first data source and said second data source based on a degree of reliability of each respective data source, and resolving said conflict using said weighting.

8. The method of claim 1, wherein said first data set and/or said second data set include raw data that is transformed to yield said first non-mobile identifier and/or said second non-mobile identifier.

9. A computer system for aggregating user data from multiple data sources for use in mobile targeted advertising, comprising:
a communication interface that is in network communication with a first data source and a second data source;
computer memory that stores users profiles associated with mobile electronic devices; and
a computer processor coupled to said communication interface and computer memory and programmed to (i) receive a first data set from said first data source, wherein said first data set comprises a mobile device identifier that uniquely identifies a mobile electronic device of a user and a first non-mobile identifier; (ii) receive a second data set from said second data source, wherein said second data set comprises said first non-mobile identifier and a second non-mobile identifier; (iii) compare said first data set to said second data set to identify said first non-mobile identifier as a match between said first data set and said second data set; (iv) associate said mobile device identifier with said second non-mobile identifier to generate a user profile of said user; and (v) store said user profile having said mobile device identifier and said second non-mobile identifier in said computer memory in a manner that is indicative of an association between said mobile device identifier and said second non-mobile identifier.

10. The computer system of claim 9, wherein said computer processor is programmed to identify a conflict between said first data set and said second data set, and resolve said conflict prior to generating said user profile.

11. The computer system of claim 10, wherein said computer processor is programmed to weight said first data source and said second data source based on a degree of reliability of each respective data source, and resolve said conflict using said weighting.

12. A method for serving targeted advertisement to a mobile electronic device of a user, comprising:
(a) receiving a mobile device identifier associated with a mobile electronic device of a user over a network, wherein said mobile device identifier uniquely identifies said mobile electronic device of said user;
(b) matching said mobile device identifier from said mobile electronic device with a user profile of said user, which user profile includes non-mobile data associated with said mobile device identifier in computer memory;
(c) receiving an advertisement request over a network, which advertisement request includes a target profile provided by an advertiser;
(d) using a programmed computer processor to compare said target profile to said user profile to determine whether said user profile substantially matches said target profile; and
(e) serving said targeted advertisement with for display on said mobile electronic device over said network if said user profile substantially matches said target profile.

13. The method of claim 12, further comprising selectively adjusting said target profile based at least in part on a response of said user to said targeted advertisement.

14. The method of claim 12, further comprising displaying said advertisement on a graphical user interface of said mobile electronic device.

15. The method of claim 12, further comprising receiving an indication that said advertisement has been viewed by said user on said mobile electronic device.

16. The method of claim 12, further comprising placing a bid in response to said advertisement request upon determining that said user profile substantially matches said target profile.

17. The method of claim 16, further comprising serving said advertisement if said bid is determined to be a winning bid.

18. The method of claim 12, wherein said non-mobile data is aggregated from raw data from one or more non-mobile data sources, transformed from said raw data to yield said non-mobile data, and stored in said computer memory in a manner that is indicative of an association between said non-mobile data and said mobile device identifier.

19. The method of claim 12, further comprising, in (d), raising said user profile to a level of abstraction of said target profile, and comparing said target profile to said user profile at said level of abstraction.

20. The method of claim 12, further comprising analyzing said user profile to determine another target profile as a derivative of said target profile, and presenting said another target profile to said advertiser for use in an advertisement campaign.
